(19) United States
(12) Patent Application Publication
(10) Pub. No.: US 2023/0167339 A1
(43) Pub. Date: Jun. 1, 2023

(54) ADHESIVE COMPOSITION, ADHESIVE SHEET, AND JOINED BODY

(71) Applicant: NITTO DENKO CORPORATION, Ibaraki-shi, Osaka (JP)

(72) Inventors: Kaori AKAMATSU, Ibaraki-shi, Osaka (JP); Mika TAKASHIMA, Ibaraki-shi, Osaka (JP); Tatsuya SUZUKI, Ibaraki-shi, Osaka (JP)

(21) Appl. No.: 17/916,074

(22) PCT Filed: Mar. 12, 2021
(86) PCT No.: PCT/JP2021/010230

§ 371 Date: Sep. 30, 2022

(30) Foreign Application Priority Data
Mar. 30, 2020 (JP) 2020-060439

(51) Int. Cl. C09J 133/08; C09J 7/38; C09J 7/28

(52) U.S. Cl. CPC C09J 133/08; C09J 7/28; C09J 7/385

(57) ABSTRACT

The present invention relates to an adhesive composition containing a polymer, an ionic liquid, and an orientation material, and an adhesive sheet including an adhesive layer formed from the adhesive composition. The adhesive composition can form an adhesive layer that has excellent adhesive strength when no voltage is applied and whose adhesive force is sufficiently decreased by applying a voltage.

### TECHNICAL FIELD

The present invention relates to an adhesive composition, an adhesive sheet including an adhesive layer formed from the adhesive composition, and a joined body of the adhesive sheet and an adherend.

### BACKGROUND ART

There is an increasing demand for rework for improving yield and recycle of disassembling and recovering components after use, in a process for producing an electronic component or the like. To respond to the demand, a double-sided adhesive sheet having certain adhesive force and certain debondability is sometimes used in allowing members to adhere to each other, in the process of producing an electronic component or the like. In addition, as electronic devices become miniaturized, an adhesive sheet having certain adhesive force and certain debondability is sometimes used in placing and fixing fine components by transfer.

As the double-sided adhesive sheet for realizing the above-described adhesive force and debondability, adhesive sheets (electrically debondable adhesive sheets) that use an ionic liquid containing cations and anions in a component of an adhesive composition and can be debonded by applying a voltage to an adhesive layer are known (Patent Literatures 1 to 3).

In the electrically debondable adhesive sheets of Patent Literatures 1 to 3, it is considered that when a voltage is applied, the cations of the ionic liquid move and reduction occurs in a cathode side; the anions of the ionic liquid move and oxidation occurs in an anode side; adhesive force at an adhesive interface is weakened; and as a result, the adhesive sheet is easy to be debonded.

### CITATION LIST

### Patent Literature

Patent Literature 1: JP 2010-037354 A
Patent Literature 2: Japanese Patent No. 6097112
Patent Literature 3: Japanese Patent No. 4139851

### SUMMARY OF INVENTION

### Technical Problem

An electrically debondable adhesive sheet preferably allows the members to firmly adhere when no voltage is applied and preferably allows the members to be debonded from each other with a small force when a voltage is applied. However, an electrically debondable adhesive sheet in the related art using an ionic liquid has a problem that, if adhesive force after voltage application is decreased, the initial adhesive force when no voltage is applied cannot be sufficiently achieved, and if the initial adhesive force when no voltage is applied is increased, the adhesive force after voltage application cannot be sufficiently decreased.

The present invention has been made under the above circumferences, and an object of the present invention is to provide an adhesive composition that can form an adhesive layer that has excellent adhesive force when no voltage is applied and whose adhesive force is sufficiently decreased by applying a voltage, and to provide an adhesive sheet including an adhesive layer formed from the adhesive composition.

### Solution to Problem

As a result of intensive studies to achieve the above object, the present inventors have found that the above problems in the related art can be solved by blending an orientation material with an adhesive composition, and have completed the present invention. That is, the present invention is as follows.

[1] An adhesive composition comprising:
a polymer;
an ionic liquid; and
an orientation material.

The adhesive composition according to [1], wherein an adhesive layer formed of the adhesive composition adheres to an adherend, and is cleaved and debonded from the adherend by applying a voltage of 10 V for 10 seconds.

The adhesive composition according to [2], wherein the cleavage-debonding is natural debonding.

The adhesive composition according to any one of [1] to [3], wherein 4 parts by mass or more of the ionic liquid is contained per 100 parts by mass of the polymer.

The adhesive composition according to any one of [1] to [4], wherein the polymer includes at least one selected from the group consisting of a polyester-based polymer, a urethane-based polymer, and an acrylic polymer.

The adhesive composition according to [5], wherein the acrylic polymer contains a unit derived from a polar group-containing monomer having a carboxyl group, an alkoxy group, a hydroxy group and/or an amide bond.

The adhesive composition according to [6], wherein a proportion of the polar group-containing monomer to total monomer components of the acrylic polymer is 0.1 to 35 mass%.

The adhesive composition according to any one of [1] to [7], which is for electrical debonding.

An adhesive sheet comprising an adhesive layer formed from the adhesive composition according to any one of [1] to [8].

A joined body comprising:
an adherend having a metal adherend surface; and
the adhesive sheet according to [9],
wherein the adhesive layer of the adhesive sheet adheres to the metal adherend surface.

### Advantageous Effects of Invention

The adhesive composition of the present invention can form an adhesive layer that has excellent adhesive strength when no voltage is applied and whose adhesive force is sufficiently decreased by applying a voltage.

### BRIEF DESCRIPTION OF DRAWINGS

FIG. 1 is a schematic cross-sectional view illustrating an example of an adhesive sheet according to the present invention.

FIG. 2 is schematic cross-sectional view illustrating an example of a laminated structure of an adhesive sheet according to the present invention.

FIG. 3 is schematic cross-sectional view illustrating another example of a laminated structure of an adhesive sheet according to the present invention.

FIG. 4 is a cross-sectional view illustrating an outline of a method of a 180° peeling test in Examples.

FIG. 5 is a schematic perspective view illustrating a test joined body used in a cleavage-debonding test in Examples.

### DESCRIPTION OF EMBODIMENTS

Hereinafter, embodiments for carrying out the present invention are described in detail. The present invention is not limited to the embodiments to be described below.

### Adhesive Composition

An adhesive composition according to an embodiment of the present invention is an adhesive composition containing a polymer, an ionic liquid, and an orientation material.

The adhesive layer formed from the adhesive composition according to the embodiment of the present invention has excellent adhesive force (initial adhesive force) when no voltage is applied, and the adhesive force is sufficiently decreased by applying a voltage. Thus, the adhesive layer can also be used in a production process of an electronic device or the like. The adhesive force is sufficiently decreased by applying a voltage, and thus cleavage-debonding can be performed. Preferably, the adhesive layer formed of the pressure-sensitive adhesive composition can be cleavage-debonded, after the adhesive layer is allowed to adhere to an adherend and then a voltage of 10 V is applied for 10 seconds.

Here, cleavage-debonding refers to debonding along an interface between an adhesive layer and an adherend. The cleavage-debonding allows for easily debonding the entire interface between the adhesive layer and the adherend, and eliminates the need for debonding by applying a large stress to a part of the interface between the adhesive layer and the adherend by peel debonding or the like. Thus, this leads to advantages that the adherend is not deformed and the like.

In the embodiments of the present invention, cleavage-debonding may be natural debonding or may not be natural debonding, but natural debonding is preferred.

In addition, natural debonding means that an adhesive layer debonds (cleavage-debond) along an interface between an adherend and the adhesive layer, and is naturally debonded without applying a stress to any part of the interface between the adhesive layer and the adherend. The natural debonding includes debonding in a stationary state, debonding naturally during movement to the next step or the like, and debonding an adherend and an adhesive layer by the weight of the adherend or the adhesive layer itself.

Examples of cleavage-debonding other than the natural debonding include a case where a slight stress is applied to a part of the interface between an adhesive layer and an adherend, so that the adhesive layer and the adherend are neither deformed nor broken, and the adhesive layer is debonded from one end of the adherend.

The adhesive composition according to the embodiment of the present invention contains a polymer, an ionic liquid, and an orientation material. When the adhesive composition contains the polymer, the ionic liquid, and the orientation material, the adhesive composition exhibits excellent adhesive force when no voltage is applied, and the adhesive force of the adhesive composition is sufficiently decreased by applying a voltage. It is considered that this is because the mobility of the ionic liquid is increased by the dielectric polarization of the orientation material when a voltage is applied.

The adhesive layer formed of the adhesive composition according to the embodiment of the present invention has a property that the adhesive layer has excellent adhesive force when no voltage is applied, the adhesive force of the adhesive composition is sufficiently decreased by applying a voltage, and the adhesive layer can be cleavage-debonded. The adhesive composition is preferable as an adhesive composition for electrical debonding.

These adhesive compositions will be described below.

In the present description, the adhesive force when no voltage is applied may be referred to as “initial adhesive force”.

The property that the adhesive force is decreased due to voltage application may be referred to as “electrical debondability”, and a large rate of decrease in adhesive force due to voltage application may be referred to as “excellent in electrical debondability”.

### Components of Adhesive Composition

### Polymer

The adhesive composition according to the embodiment of the present invention contains a polymer. In the present embodiment, the polymer is not limited as long as it is a typical organic polymer compound, and is, for example, a polymer or a partially polymerized product of monomers. The monomers may be one kind of monomer and may be a monomer mixture of two or more kinds of monomers. The term “partially polymerized product” refers to a polymer in which the monomer or at least a part of the monomer mixture is partially polymerized.

The polymer in the embodiment of the present invention is not limited as long as it is typically used as an adhesive and has adhesiveness, and examples thereof include an acrylic polymer, a rubber-based polymer, a vinyl alkyl ether-based polymer, a silicone-based polymer, a polyester-based polymer, a polyamide-based polymer, a urethane-based polymer, a fluorine-based polymer, and an epoxy-based polymer. The polymer may be used alone or in combination of two or more kinds thereof.

To obtain an adhesive layer that has excellent adhesive force when no voltage is applied and whose adhesive force is sufficiently decreased by applying a voltage, the polymer preferably has a large relative dielectric constant. From this viewpoint, the polymer in the present embodiment preferably contains at least one selected from the group consisting of a polyester-based polymer, a urethane-based polymer, and an acrylic polymer.

The acrylic polymer preferably contains a unit derived from a polar group-containing monomer having a carboxyl group, an alkoxy group, a hydroxy group and/or an amide bond. The polyester-based polymer and the urethane-based polymer have, at the terminal, a hydroxy group that is easily polarized, and in the acrylic polymer having a carboxyl group, an alkoxy group, a hydroxy group and/or an amide bond, the carboxyl group, the alkoxy group, the hydroxy group and/or the amide bond are easily polarized. Thus, the use of these polymer allows for providing a polymer that has excellent adhesive force when no voltage is applied and whose adhesive force is sufficiently decreased by applying a voltage.

The total content of the polyester-based polymer, the urethane-based polymer, and the acrylic polymer in the polymer of the present embodiment is preferably 60 mass% or more, and more preferably 80 mass% or more.

In particular, in order to increase the cost, productivity, and initial adhesive force, the polymer in the present embodiment is preferably an acrylic polymer.

That is, the adhesive composition according to the embodiment of the present invention is preferably an acrylic adhesive composition containing an acrylic polymer as a polymer.

The acrylic polymer preferably contains a monomer unit derived from an alkyl (meth)acrylate having an alkyl group having 1 to 14 carbon atoms (the following formula (1)). Such a monomer unit is preferable for obtaining a large initial adhesive force. The alkyl group R^{b} in the following formula (1) preferably has a small amount of carbon atoms, particularly preferably 8 or less carbon atoms, and more preferably 4 or less carbon atoms in order to improve the electrical debondability.

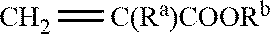

[In the formula (1), R^{a} represents a hydrogen atom or a methyl group, and R^{b} represents an alkyl group having 1 to 14 carbon atoms]

Examples of the alkyl (meth)acrylate having an alkyl group having 1 to 14 carbon atoms include methyl (meth)acrylate, ethyl (meth)acrylate, propyl (meth)acrylate, isopropyl (meth)acrylate, n-butyl (meth)acrylate, sec-butyl (meth)acrylate, 1,3-dimethylbutyl acrylate, pentyl (meth)acrylate, isopentyl (meth)acrylate, hexyl (meth)acrylate, 2-ethylbutyl (meth)acrylate, heptyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate. Of these, n-butyl acrylate, 2-ethylhexyl acrylate, and isononyl acrylate are preferred. The alkyl (meth)acrylate having an alkyl group having 1 to 14 carbon atoms may be used alone or in combination of two or more kinds thereof.

The proportion of alkyl (meth)acrylate having an alkyl group having 1 to 14 carbon atoms to the total monomer components (100 mass%) of the acrylic polymer is not limited, but is preferably 70 mass% or more, more preferably 80 mass% or more, and still more preferably 85 mass% or more. When the proportion of the alkyl (meth)acrylate having an alkyl group having 1 to 14 carbon atoms is 70 mass% or more, a large initial adhesive force is easily achieved.

In addition to a monomer unit derived from alkyl (meth)acrylate having an alkyl group having 1 to 14 carbon atoms, the acrylic polymer preferably further contains a monomer unit derived from a polar group-containing monomer copolymerizable with the monomer unit derived from alkyl (meth)acrylate, for the purpose of modifying cohesive force, heat resistance, crosslinking properties, and the like. Such a monomer unit is preferable as a crosslinking point can be imparted and a large initial adhesive force is obtained.

Examples of the polar group-containing monomer include a carboxyl group-containing monomer, an alkoxy group-containing monomer, a hydroxy group-containing monomer, a cyano group-containing monomer, a vinyl group-containing monomer, an aromatic vinyl monomer, an amide group-containing monomer, an imide group-containing monomer, an amino group-containing monomer, an epoxy group-containing monomer, a vinyl ether monomer, an N-acryloyl morpholine, a sulfo group-containing monomer, a phosphate group-containing monomer, and an acid anhydride group-containing monomer. Of these, from the viewpoint of excellent cohesiveness, a carboxyl group-containing monomer, an alkoxy group-containing monomer, a hydroxy group-containing monomer, and an amide group-containing monomer are preferred, and a carboxyl group-containing monomer is particularly preferred. A carboxyl group-containing monomer is particularly preferable as a particularly large initial adhesive force is obtained. The polar group-containing monomer may be used alone or in combination of two or more kinds thereof.

Examples of the carboxyl group-containing monomer include acrylic acid, methacrylic acid, carboxyethyl (meth)acrylate, carboxypentyl (meth)acrylate, itaconic acid, maleic acid, fumaric acid, crotonic acid, and isocrotonic acid. Acrylic acid is particularly preferred. The carboxyl group-containing monomer may be used alone or in combination of two or more kinds thereof.

Examples of the alkoxy group-containing monomer include a methoxy group-containing monomer and an ethoxy group-containing monomer. Examples of the methoxy group-containing monomer include 2-methoxyethyl acrylate.

Examples of the hydroxy group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl (meth)acrylate, N-methylol (meth)acrylamide, vinyl alcohol, allyl alcohol, 2-hydroxyethyl vinyl ether, 4-hydroxybutyl vinyl ether, and diethylene glycol monovinyl ether. 2-hydroxyethyl (meth)acrylate and 4-hydroxybutyl (meth)acrylate are particularly preferred. The hydroxy group-containing monomer may be used alone or in combination of two or more kinds thereof.

Examples of the amide group-containing monomer include acrylamide, methacrylamide, N-vinyl pyrrolidone, N,N-dimethylacrylamide, N,N-dimethyl methacrylamide, N,N-diethylacrylamide, N,N-diethyl methacrylamide, N,N′-methylenebisacrylamide, N,N-dimethylaminopropyl acrylamide, N,N-dimethylaminopropyl methacrylamide, and diacetone acrylamide. The amide group-containing monomer may be used alone or in combination of two or more kinds thereof.

Examples of the cyano group-containing monomer include acrylonitrile and methacrylonitrile.

Examples of the vinyl group-containing monomer include vinyl esters such as vinyl acetate, vinyl propionate, and vinyl laurate, and vinyl acetate is particularly preferred.

Examples of the aromatic vinyl monomer include styrene, chlorostyrene, chloromethylstyrene, α-methylstyrene, and other substituted styrenes.

Examples of the imide group-containing monomer include cyclohexyl maleimide, isopropyl maleimide, N-cyclohexyl maleimide, and itaconimide.

Examples of the amino group-containing monomer include aminoethyl (meta)acrylate, N,N-dimethylaminoethyl (meth)acrylate, and N,N-dimethylaminopropyl (meth)acrylate.

Examples of the epoxy group-containing monomer include glycidyl (meth)acrylate, methylglycidyl (meth)acrylate, and allyl glycidyl ether.

Examples of the vinyl ether monomer include methyl vinyl ether, ethyl vinyl ether, and isobutyl vinyl ether.

The proportion of the polar group-containing monomer to the total monomer components (100 mass%) of the acrylic polymer is preferably 0.1 mass% or more and 35 mass% or less. The upper limit of the proportion of the polar group-containing monomer is more preferably 25 mass%, and still more preferably 20 mass%. The lower limit of the proportion is more preferably 0.5 mass%, still more preferably 1 mass%, and particularly preferably 2 mass%. When the proportion of the polar group-containing monomer is 0.1 mass% or more, cohesive force is easily achieved, and thus, the adhesive residue is less likely to be generated on a surface of the adherend after the adhesive layer is debonded, and the electrical debondability is improved. When the proportion of the polar group-containing monomer is 35 mass% or less, it is easy to prevent the adhesive layer from excessively adhering to the adherend and causing heavy debonding. In particular, when the proportion is 2 mass% or more and 20 mass% or less, both the debondability to an adherend and the adhesion between the adhesive layer and another layer can be easily achieved.

As the monomer component of the acrylic polymer, a polyfunctional monomer may be contained in order to introduce a crosslinked structure into the acrylic polymer to easily obtain a necessary cohesive force.

Examples of the polyfunctional monomer include ethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and N,N′-methylenebisacrylamide. The polyfunctional monomer may be used alone or in combination of two or more kinds thereof.

The content of the polyfunctional monomer relative to the total monomer components (100 mass%) of the acrylic polymer is preferably 0.1 mass% or more and 15 mass% or less. The upper limit of the content of the polyfunctional monomer is more preferably 10 mass%, and the lower limit thereof is more preferably 3 mass%. The content of the polyfunctional monomer is preferably 0.1 mass% or more as flexibility and adhesiveness of the adhesive layer are easily improved. When the content of the polyfunctional monomer is 15 mass% or less, the cohesive force does not become too high, and appropriate adhesiveness is easily achieved.

The polyester-based polymer is typically a polymer having a structure obtained by condensing a polyvalent carboxylic acid such as a dicarboxylic acid or a derivative thereof (hereinafter, also referred to as “polyvalent carboxylic acid monomer”) and a polyhydric alcohol such as a diol or a derivative thereof (hereinafter, referred to as “polyhydric alcohol monomer”).

The polyvalent carboxylic acid monomer is not limited, but examples thereof include adipic acid, azelaic acid, dimer acid, sebacic acid, 1,4-cyclohexanedicarboxylic acid, 1,3-cyclohexanedicarboxylic acid, 1,2-cyclohexanedicarboxylic acid, 4-methyl-1,2-cyclohexanedicarboxylic acid, dodecenyl succinic anhydride, fumaric acid, succinic acid, dodecanedioic acid, hexahydrophthalic anhydride, tetrahydrophthalic anhydride, maleic acid, maleic anhydride, itaconic acid, citraconic acid, and derivatives thereof.

The polyvalent carboxylic acid monomer may be used alone or in combination of two or more kinds thereof.

The polyhydric alcohol monomer is not limited, but examples thereof include ethylene glycol, 1,2-propylene glycol, 1,3-propanediol, 2-methyl-1,3-propanediol, 1,2-butanediol, 1,3-butanediol, 1,4-butanediol, 1,5-pentanediol, 1,6-hexanediol, 3-methyl-1,5-pentanediol, neopentyl glycol, diethylene glycol, dipropylene glycol, 2,2,4-trimethyl-1,5-pentanediol, 2-ethyl-2-butyl propanediol, 1,9-nonanediol, 2-methyloctanediol, 1,10-decanediol, and derivatives thereof.

The polyhydric alcohol monomer may be used alone or in combination of two or more kinds thereof.

The polymer of the present embodiment may contain an ionic polymer. The ionic polymer is a polymer having an ionic functional group. When the polymer contains an ionic polymer, the electrical debondability is improved. When the polymer contains an ionic polymer, the content of the ionic polymer is preferably 0.05 parts by mass or more and 2 parts by mass or less per 100 parts by mass of the polymer.

In the present embodiment, the polymer can be obtained by (co)polymerizing monomer components. The polymerization method is not limited, but examples thereof include a solution polymerization, an emulsion polymerization, a bulk polymerization, a suspension polymerization, and a photopolymerization (active energy ray polymerization). In particular, the solution polymerization is preferred from the viewpoint of cost and productivity. In the case of copolymerization, the polymer may be any of a random copolymer, a block copolymer, an alternating copolymer, a graft copolymer, and the like.

The solution polymerization is not limited, but examples thereof include a method in which monomer components, a polymerization initiator, and the like are dissolved in a solvent, followed by heating the resultant solution to perform polymerization, and a polymer solution containing a polymer is obtained.

As the solvent used in the solution polymerization, various general solvents may be used. Examples of such a solvent (polymerization solvent) include organic solvents such as: aromatic hydrocarbons such as toluene, benzene, and xylene; esters such as ethyl acetate and n-butyl acetate; aliphatic hydrocarbons such as n-hexane and n-heptane; alicyclic hydrocarbons such as cyclohexane and methylcyclohexane; and ketones such as methyl ethyl ketone and methyl isobutyl ketone. The solvent may be used alone or in combination of two or more kinds thereof.

The amount of the solvent to be used is not limited, and is preferably 10 parts by mass or more and 1,000 parts by mass or less relative to the total monomer components (100 parts by mass) of the polymer. The upper limit of the amount of the solvent to be used is more preferably 500 parts by mass, and the lower limit thereof is more preferably 50 parts by mass.

The polymerization initiator to be used in the solution polymerization method is not limited, but examples thereof include a peroxide-based polymerization initiator and an azo-based polymerization initiator.

The peroxide-based polymerization initiator is not limited, but examples thereof include peroxycarbonates, ketone peroxides, peroxyketals, hydroperoxides, dialkyl peroxides, diacyl peroxides, and peroxyesters, and more specific examples thereof include benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy) cyclododecane.

The azo-based polymerization initiator is not limited, but examples thereof include 2,2′-azobisisobutyronitrile, 2,2′-azobis-2-methylbutyronitrile, 2,2′-azobis(2,4-dimethylvaleronitrile), dimethyl 2,2′-azobis (2-methylpropionate), 2,2′-azobis(4-methoxy-2,4-dimethylvaleronitrile), 1,1′-azobis (cyclohexane-1-carbonitrile), 2,2′-azobis(2,4,4-trimethylpentane), 4,4′-azobis-4-cyanovaleric acid, 2,2′-azobis(2-amidinopropane) dihydrochloride, 2,2′-azobis[2-(5-methyl-2-imidazolin-2-yl) propane] dihydrochloride, 2,2′-azobis(2-methylpropionamidine) disulfate, 2,2′-azobis(N,N′-dimethyleneisobutylamidine) hydrochloride, and 2,2′-azobis[N-(2-carboxyethyl)-2-methylpropion amidine] hydrate. The polymerization initiator may be used alone or in combination of two or more kinds thereof.

The amount of the polymerization initiator to be used is not limited, but is preferably 0.01 parts by mass or more and 5 parts by mass or less relative to the total monomer components (100 parts by mass) of the polymer. The upper limit of the amount of the polymerization initiator to be used is more preferably 3 parts by mass, and the lower limit thereof is more preferably 0.05 parts by mass.

The heating temperature for the polymerization by heating in the solution polymerization method is not limited, but is, for example, 50° C. or higher and 80° C. or lower. The heating time is not limited, but is, for example, 1 hour or longer and 24 hours or shorter.

The weight average molecular weight of the polymer is not limited, but is preferably 100,000 or more and 5,000,000 or less. The upper limit of the weight average molecular weight is more preferably 4,000,000, and still more preferably 3,000,000, and the lower limit thereof is more preferably 200,000, and still more preferably 300,000. When the weight average molecular weight is 100,000 and 5,000,000 or less, a sufficient adhesive force is obtained.

The weight average molecular weight is obtained by performing measurement with gel permeation chromatography (GPC), and more specifically, for example, the weight average molecular weight can be measured under the following conditions using a GPC measurement apparatus with a trade name “HLC-8220GPC” (manufactured by Tosoh Corporation), and can be calculated according to standard polystyrene conversion values.

### Measurement Conditions of Weight Average Molecular Weight

Sample concentration: 0.2 mass% (tetrahydrofuran solution)
Sample injection amount: 10 µL
Sample column: TSK guard column Super HZ-H (one column) + TSK gel Super HZM-H (two columns)
Reference column: TSK gel Super H-RC (one column)
Eluent: Tetrahydrofuran (THF)
Flow rate: 0.6 mL/min
Detector: differential refractometer (RI)
Column temperature (measurement temperature): 40° C.

The glass transition temperature (Tg) of the polymer is not limited, but is preferably 0° C. or lower because a decrease in initial adhesive force can be prevented, more preferably -10° C. or lower, and still more preferably -20° C. or lower. The glass transition temperature is particularly preferably -40° C. or lower because the rate of decrease in adhesive force due to voltage application is particularly increased, and most preferably -50° C. or lower.

The glass transition temperature (Tg) can be calculated, for example, based on the following formula (Y) (Fox formula).

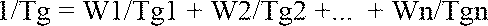

[In the formula (Y), Tg represents the glass transition temperature (unit: K) of the polymer, Tgi (i = 1, 2, n) represents the glass transition temperature (unit: K) when the monomer i forms a homopolymer, and Wi (i = 1, 2, n) represents the mass fraction of the monomer i in total monomer components.]

The above formula (Y) is a calculation formula when the polymer includes n kinds of monomer components of monomer 1, monomer 2, , and monomer n.

The glass transition temperature when a homopolymer is formed means the glass transition temperature of a homopolymer of the monomer, and means the glass transition temperature (Tg) of a polymer formed by using only a certain monomer (sometimes referred to as “monomer X”) as a monomer component. Specifically, numerical values are listed in “Polymer Handbook” (3rd edition, John Wiley & Sons, Inc., 1989). The glass transition temperature (Tg) of a homopolymer that is not described in this literature refers to, for example, a value obtained by the following measurement method. That is, 100 parts by mass of the monomer X, 0.2 parts by mass of 2,2′-azobisisobutyronitrile, and 200 parts by mass of ethyl acetate as a polymerization solvent are put into a reactor equipped with a thermometer, a stirrer, a nitrogen inlet tube, and a reflux condenser, and the mixture is stirred for 1 hour while introducing nitrogen gas. After oxygen in the polymerization system is removed in this manner, the temperature is raised to 63° C. and the reaction is carried out for 10 hours. Next, the mixture is cooled to room temperature to obtain a homopolymer solution having a solid content concentration of 33 mass%. Next, the homopolymer solution is cast and applied onto a release liner and dried to prepare a test sample (sheet-shaped homopolymer) having a thickness of about 2 mm. Then, about 1 to 2 mg of the test sample is weighed in an aluminum open cell, and a temperature modulated DSC (trade name “Q-2000”, manufactured by TA Instruments Inc.) is used to obtain a reversing heat flow (specific heat component) behavior of a homopolymer under a nitrogen atmosphere of 50 ml/min at a temperature rising rate of 5° C./min. With reference to JIS-K-7121, a temperature at a point where a straight line equidistant in a vertical axis direction from a straight line obtained by extending a base line on the low temperature side and a base line on the high temperature side of the obtained reversing heat flow intersects a curve of a stepwise change portion of the glass transition is defined as a glass transition temperature (Tg) when a homopolymer is formed.

The content of the polymer in the adhesive composition of the present embodiment is preferably 50 mass% or more and 99.9 mass% or less relative to the total amount (100 mass%) of the adhesive composition. The upper limit is more preferably 99.5 mass%, and still more preferably 99 mass%, and the lower limit is more preferably 60 mass%, and still more preferably 70 mass%.

### Ionic Liquid

The ionic liquid in the present embodiment is not limited as long as it is a molten salt (room temperature molten salt) that includes a pair of an anion and a cation and is a liquid at 25° C. Examples of the anion and the cation are given below, and among ionic substances obtained by combining these, ionic substances that are liquid at 25° C. are ionic liquids, and ionic substances that are solid at 25° C. are not ionic liquids but ionic solids described below.

Examples of the anion of the ionic liquid include (FSO₂)₂N⁻, (CF₃SO₂)₂N⁻, (CF₃CF₂SO₂)₂N-, (CF₃SO₂)₃C-, Br⁻, AlCl₄⁻ , Al₂Cl₇⁻, NO₃⁻, BF₄⁻, PF₆⁻, CH₃COO⁻ , CF₃COO⁻, CF₃CF₂CF₂COO⁻, CF₃SO₃⁻, CF₃(CF₂)₃SO₃⁻, AsF₆⁻, SbF₆⁻, and F(HF)n⁻. Among these, as the anion, an anion of a sulfonylimide compound such as (FSO₂)₂N⁻[bis(fluorosulfonyl)imide anion] and (CF₃SO₂)₂N⁻[bis(trifluoromethanesulfonyl)imide anion] is preferred as it is chemically stable and is suitable for improving electrical debondability.

As the cations in the ionic liquid, nitrogen-containing onium cations, sulfur-containing onium cations, and phosphorus-containing onium cations are preferred as they are chemically stable and are suitable for improving the electrical debondability, and imidazolium cations, ammonium cations, pyrrolidinium cations, and pyridinium cations are more preferred.

Examples of the imidazolium cations include 1-methylimidazolium cations, 1-ethyl-3-methylimidazolium cations, 1-propyl-3-methylimidazolium cations, 1-butyl-3-methylimidazolium cations, 1-pentyl-3-methylimidazolium cations, 1-hexyl-3-methylimidazolium cations, 1-heptyl-3-methylimidazolium cations, 1-octyl-3-methylimidazolium cations, 1-nonyl-3-methylimidazolium cations, 1-undecyl-3-methylimidazolium cations, 1-dodecyl-3-methylimidazolium cations, 1-tridecyl-3-methylimidazolium cations, 1-tetradecyl-3-methylimidazolium cations, 1-pentadecyl-3-methylimidazolium cations, 1-hexadecyl-3-methylimidazolium cations, 1-heptadecyl-3-methylimidazolium cations, 1-octadecyl-3-methylimidazolium cations, 1-undecyl-3-methylimidazolium cations, 1-benzyl-3-methylimidazolium cations, 1-butyl-2,3-dimethylimidazolium cations, and 1,3-bis(dodecyl)imidazolium cations.

Examples of the pyridinium cations include 1-butylpyridinium cations, 1-hexylpyridinium cations, 1-butyl-3-methylpyridinium cations, 1-butyl-4-methylpyridinium cations, and 1-octyl-4-methylpyridinium cations.

Examples of the pyrrolidinium cations include 1-ethyl-1-methylpyrrolidinium cations and 1-butyl-1-methylpyrrolidinium cations.

Examples of the ammonium cations include tetraethylammonium cations, tetrabutylammonium cations, methyltrioctylammonium cations, tetradecyltrihexylammonium cations, glycidyltrimethylammonium cations, and trimethylaminoethylacrylate cations.

As the ionic liquid, from the viewpoint of increasing the rate of decrease in the adhesive force during voltage application, it is preferable to select cations having a molecular weight of 160 or less as the cations constituting the ionic liquid, and an ionic liquid containing (FSO₂)₂N⁻[bis(fluorosulfonyl)imide anion] or (CF₃SO₂)₂N⁻[bis(trifluoromethanesulfonyl)imide anion] described above and the cations having a molecular weight of 160 or less is particularly preferred. Examples of the cations having a molecular weight of 160 or less include 1-methylimidazolium cations, 1-ethyl-3-methylimidazolium cations, 1-propyl-3-methylimidazolium cations, 1-butyl-3-methylimidazolium cations, 1-pentyl-3-methylimidazolium cations, 1-butylpyridinium cations, 1-hexylpyridinium cations, 1-butyl-3-methylpyridinium cations, 1-butyl-4-methylpyridinium cations, 1-ethyl-1-methylpyrrolidinium cations, 1-butyl-1-methylpyrrolidinium cations, tetraethylammonium cations, glycidyltrimethylammonium cations, and trimethylaminoethylacrylate cations.

As the cations of the ionic liquid, cations represented by the following formula (2-A) to (2-D) are also preferred.

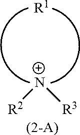

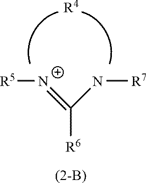

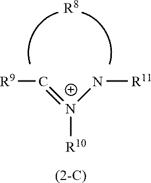

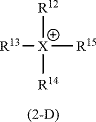

R¹ in the formula (2-A) represents a hydrocarbon group having 4 to 10 carbon atoms (preferably a hydrocarbon group having 4 to 8 carbon atoms, and more preferably a hydrocarbon group having 4 to 6 carbon atoms) and may contain a hetero atom, and R² and R³ are the same as or different from each other and represent a hydrogen atom or a hydrocarbon group having 1 to 12 carbon atoms (preferably a hydrocarbon group having 1 to 8 carbon atoms, more preferably a hydrocarbon group having 2 to 6 carbon atoms, and still more preferably a hydrocarbon group having 2 to 4 carbon atoms) and may contain a hetero atom. However, when a nitrogen atom forms a double bond with an adjacent carbon atom, R³ is not present.

In the formula (2-B), R⁴ represents a hydrocarbon group having 2 to 10 carbon atoms (preferably a hydrocarbon group having 2 to 8 carbon atoms, and more preferably a hydrocarbon group having 2 to 6 carbon atoms) and may contain a hetero atom, and R⁵, R⁶, and R⁷ are the same as or different from one another and represent a hydrogen atom or a hydrocarbon group having 1 to 12 carbon atoms (preferably a hydrocarbon group having 1 to 8 carbon atoms, more preferably a hydrocarbon group having 2 to 6 carbon atoms, and still more preferably a hydrocarbon group having 2 to 4 carbon atoms) and may contain a hetero atom.

In the formula (2-C), R⁸ represents a hydrocarbon group having 2 to 10 carbon atoms (preferably a hydrocarbon group having 2 to 8 carbon atoms, and more preferably a hydrocarbon group having 2 to 6 carbon atoms) and may contain a hetero atom, and R⁹, R¹⁰, and R¹¹ are the same as or different from one another and represent a hydrogen atom or a hydrocarbon group having 1 to 16 carbon atoms (preferably a hydrocarbon group having 1 to 10 carbon atoms, and more preferably a hydrocarbon group having 1 to 8 carbon atoms) and may contain a hetero atom.

In the formula (2-D), X represents a nitrogen atom, a sulfur atom, or a phosphorus atom, and R¹², R¹³, R¹⁴, and R¹⁵ are the same as or different from one another and represent a hydrocarbon group having 1 to 16 carbon atoms (preferably a hydrocarbon group having 1 to 14 carbon atoms, more preferably a hydrocarbon group having 1 to 10 carbon atoms, still more preferably a hydrocarbon group having 1 to 8 carbon atoms, particularly preferably a hydrocarbon group having 1 to 6 carbon atoms), and may contain a hetero atom. However, when X is a sulfur atom, R¹² is not present.

The molecular weight of the cation in the ionic liquid is, for example, 500 or less, preferably 400 or less, more preferably 300 or less, still more preferably 250 or less, particularly preferably 200 or less, and most preferably 160 or less. In addition, the molecular weight is generally 50 or more. It is considered that the cations in the ionic liquid have a property of moving to a cathode side in the adhesive layer during voltage application, and gathering a vicinity of the interface between the adhesive layer and the adherend. Therefore, in the present invention, the adhesive force during voltage application is decreased relative to the initial adhesive force, and the electrical debondability is generated. The cation having a small molecular weight, such as a molecular weight of 500 or less, is easy to move to the cathode side in the adhesive layer, and is suitable for increasing the rate of decrease in the adhesive force during voltage application.

Examples of commercially available products of the ionic liquid include “ELEXCEL AS-210”, “ELEXCEL AS-110”, “ELEXCEL MP-442”, “ELEXCEL IL-210”, “ELEXCEL MP-471”, “ELEXCEL MP-456”, and “ELEXCEL AS-804” manufactured by DKS Co. Ltd., “HMI-FSI” manufactured by Mitsubishi Materials Corporation, “CIL-312” and “CIL-313” manufactured by Japan Carlit Co., Ltd..

The ionic conductivity of the ionic liquid is preferably 0.1 mS/cm or more and 10 mS/cm or less. The upper limit of the ionic conductivity is more preferably 5 mS/cm, and still more preferably 3 mS/cm, and the lower limit thereof is more preferably 0.3 mS/cm, and still more preferably 0.5 mS/cm. When the ionic conductivity is within this range, the adhesive force is sufficiently decreased even at a low voltage. The ionic conductivity can be measured by an AC impedance method using, for example, a 1260 frequency response analyzer manufactured by Solartron Metrology.

The content (blending amount) of the ionic liquid in the adhesive composition of the present embodiment is preferably 4 parts by mass or more per 100 parts by mass of the polymer from the viewpoint of reducing the adhesive force during voltage application, and is preferably 50 parts by mass or less from the viewpoint of increasing the initial adhesive force. From the same viewpoint, the content is more preferably 40 parts by mass or less, still more preferably 30 parts by mass or less, particularly preferably 25 parts by mass or less, and most preferably 20 parts by mass or less. The content is more preferably 8 parts by mass or more, still more preferably 10 parts by mass or more, particularly preferably 12 parts by mass or more, and most preferably 15 parts by mass or more.

### Orientation Material

The adhesive composition according to the embodiment of the present invention contains an orientation material in addition to the polymer and the ionic liquid.

The orientation material refers to a material that is dielectrically polarized by an electric field and easily oriented in a specific direction.

Examples of the orientation material to be used in the embodiment of the present invention include a liquid crystal monomer and a liquid crystal polymer, and the liquid crystal monomer is preferred.

As the liquid crystal monomer, any of lyotropic monomers and thermotropic monomers can be used, but thermotropic monomers are preferred from the viewpoint of workability, and examples thereof include a monomer having, as a basic skeleton, a biphenyl derivative, a phenyl benzoate derivative, a stilbene derivative, or a bicyclohexyl derivative, into which a functional group such as an acryloyl group, a vinyl group, or an epoxy group is introduced.

It is preferable to use a method in which the liquid crystal monomers are orientated using an appropriate known method such as a method using heat or light or a method of adding an orientation aid, and then the liquid crystal monomers are crosslinked and polymerized by light, heat, an electron beam or the like with the orientation maintained, thereby fixing the orientation.

The liquid crystal monomer may be a liquid crystal molecule that has a property of exhibiting ionic conductivity, and may be non-polymerizable. In other words, the liquid crystal monomer may not have a polymerizable functional group, and may be a liquid crystal molecule having no polymerizable functional group. The liquid crystal molecule is a low-molecular-weight liquid crystal compound having a molecular weight of less than 10,000, preferably 1,000 or less.

The liquid crystal monomer is not limited to a substance showing liquid crystallinity at room temperature (25° C.), and a molecule exhibiting liquid crystallinity at a higher temperature may be used.

Even in case of molecules, as a single substance, exhibiting no liquid crystallinity unless the temperature exceeds 40° C., the lower limit of the temperature at which the molecules exhibit liquid crystallinity may be decreased to 40° C. or lower by mixing the molecules with another liquid crystal molecules.

Examples of the liquid crystal monomer showing liquid crystallinity at 40° C. lower include: cyanobiphenyl-based liquid crystals such as 4′-pentylbiphenyl-4-carbonitrile, 4′-hexylbiphenyl-4-carbonitrile, and 4′-heptylbiphenyl-4-carbonitrile; cyanophenylbenzoate-based liquid crystals such as 4-cyanophenyl-4-butylbenzoate; pyrimidine-based liquid crystals such as 5-n-heptyl-2-[4-(n-hexyloxy) phenyl] pyrimidine, and 5-n-octyl-2-[4-(n-octyloxy) phenyl] pyrimidine; tolan-based liquid crystals such as 1-(4-ethylphenyl)-2-(4-methoxyphenyl) acetylene, and 1-(4-n-butylphenyl)-2-(4-methoxyphenyl) acetylene, but are not limited to these. All of the liquid crystal molecules exemplified above are non-polymerizable liquid crystal molecules.

In addition to two kinds of liquid crystal molecules, three or more kinds of liquid crystal molecules may be blended.

Examples of the liquid crystal polymer include various main chain type and side chain type polymers in which a conjugated linear atomic group (mesogen), which imparts liquid crystal orientation properties, is introduced into a main chain or a side chain of the polymer. Specific examples of the main chain type liquid crystal polymer include a nematically oriented polyester-based liquid crystal polymer, a discotic polymer, and a cholesteric polymer, each having a structure in which a mesogen group is allowed to bond to a spacer part that imparts flexibility. Specific examples of the side chain type liquid crystal polymer include liquid crystal polymers that have, as a main chain skeleton, polysiloxane, polyacrylate, polymethacrylate, or polymalonate, and that have, as a side chain, a mesogen moiety including a para-substituted cyclic compound unit with a nematic orientation imparting property via a spacer moiety formed by a conjugated atomic group.

The content (blending amount) of the orientation material in the adhesive composition of the present embodiment is preferably 0.05 parts by mass or more per 100 parts by mass of the polymer from the viewpoint of decreasing the adhesive force during voltage application and is preferably 30 parts by mass or less per 100 parts by mass of the polymer from the viewpoint of increasing the initial adhesive force. From the same viewpoint, the content is more preferably 20 parts by mass or less, still more preferably 10 parts by mass or less, particularly preferably 8 parts by mass or less, and most preferably 5 parts by mass or less. The content is more preferably 0.1 parts by mass or more, still more preferably 0.5 parts by mass or more, particularly preferably 1 part by mass or more, and most preferably 1.5 parts by mass or more.

### Other Components

The adhesive composition of the present embodiment may contain one kind or two or more kinds of components (hereinafter, may be referred to as “other components”) other than the polymer, the ionic liquid, and the orientation material as necessary, as long as the effects of the present invention are not impaired. Hereinafter, other components that may be contained in the adhesive composition of the present embodiment will be described.

The adhesive composition of the present embodiment may contain an ionic additive for the purpose of imparting excellent adhesive force (initial adhesive force) when no voltage is applied and sufficiently reducing the adhesive force by applying a voltage. As the ionic additive, for example, an ionic solid may be used.

The ionic solid is an ionic substance that is a solid at 25° C. The ionic solid is not limited, but for example, a solid ionic substance may be used among ionic substances obtained by combining an anion and a cation exemplified in the description of the ionic liquid described above. When the adhesive composition contains an ionic solid, the content of the ionic solid is preferably 0.5 parts by mass or more, and more preferably 1 part by mass or more, and is preferably 10 parts by mass or less, more preferably 5 parts by mass or less, and still more preferably 2.5 parts by mass or less per 100 parts by mass of the polymer.

The adhesive composition of the present embodiment may contain a crosslinking agent as necessary for the purpose of improving creep properties and shear properties by crosslinking the polymer. Examples of the crosslinking agent include an isocyanate-based crosslinking agent, a carbodiimide-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, an oxazoline-based crosslinking agent, an aziridine-based crosslinking agent, and an amine-based crosslinking agent. Examples of the isocyanate-based crosslinking agent include toluene diisocyanate and methylene bisphenyl isocyanate. Examples of the epoxy-based crosslinking agent include N,N,N′,N′-tetraglycidyl-m-xylenediamine, diglycidyl aniline, 1,3-bis(N,N-diglycidylaminomethyl) cyclohexane, and 1,6-hexanediol diglycidyl ether. When the adhesive composition contains the crosslinking agent, the content of the crosslinking agent is preferably 0.1 parts by mass or more, and more preferably 0.7 parts by mass or more, and is preferably 50 parts by mass or less, more preferably 10 parts by mass or less, and still more preferably 3 parts by mass or less, per 100 parts by mass of the polymer. The crosslinking agent may be used alone or in combination of two or more kinds thereof.

The adhesive composition of the present embodiment may contain polyethylene glycol or tetraethylene glycol dimethyl ether as necessary for the purpose of assisting the movement of the ionic liquid during voltage application. Polyethylene glycol and tetraethylene glycol dimethyl ether having a number average molecular weight of 100 to 6,000 may be used. When the adhesive composition contains these components, the content of these components is preferably 0.1 parts by mass or more, more preferably 0.5 parts by mass or more, and still more preferably 1 part by mass or more, and is preferably 30 parts by mass or less, more preferably 20 parts by mass or less, and still more preferably 15 parts by mass or less, per 100 parts by mass of the polymer.

The adhesive composition of the present embodiment may contain a conductive filler as necessary for the purpose of imparting conductivity to the adhesive composition. The conductive filler is not limited, and a generally known or common conductive filler may be used. For example, graphite, carbon black, carbon fibers, a metal powder of silver, copper, or the like may be used. When the adhesive composition contains the conductive filler, the content of the conductive filler is preferably 0.1 parts by mass or more and 200 parts by mass or less per 100 parts by mass of the polymer.

The adhesive composition of the present embodiment may contain a corrosion inhibitor as necessary for the purpose of preventing corrosion of a metal adherend. The corrosion inhibitor is not limited, and a generally known or common corrosion inhibitor may be used. For example, a carbodiimide compound, an adsorption inhibitor, a chelate-forming metal inactivating agent, or the like may be used.

Examples of the carbodiimide compound include 1-[3-(dimethylamino) propyl]-3-ethylcarbodiimide, 1-ethyl-3-(3-dimethylaminopropyl) carbodiimide, N,N′-dicyclohexylcarbodiimide, N,N′-diisopropylcarbodiimide, 1-ethyl-3-tert-butylcarbodiimide, N-cyclohexyl-N′-(2-morpholinoethyl) carbodiimide, N,N′-di-tert-butylcarbodiimide, 1,3-bis(p-tolyl) carbodiimide, and polycarbodiimide resins containing these as monomers. One of these carbodiimide compounds may be used alone, or two or more kinds thereof may be used in combination. When the adhesive composition of the present embodiment contains the carbodiimide compound, the content of the carbodiimide compound is preferably 0.01 parts by mass or more and 10 parts by mass or less per 100 parts by mass of the polymer.

Examples of the adsorption inhibitor include an alkylamine, a carboxylic acid salt, a carboxylic acid derivative, and an alkyl phosphate salt. The adsorption inhibitor may be used alone or in combination of two or more kinds thereof. When the adhesive composition of the present embodiment contains the alkylamine as the adsorption inhibitor, the content of the alkylamine is preferably 0.01 parts by mass or more and 20 parts by mass or less, per 100 parts by mass of the polymer. When the adhesive composition of the present embodiment contains the carboxylic acid salt as the adsorption inhibitor, the content of the carboxylic acid salt is preferably 0.01 parts by mass or more and 10 parts by mass or less, per 100 parts by mass of the polymer. When the adhesive composition of the present embodiment contains the carboxylic acid derivative as the adsorption inhibitor, the content of the carboxylic acid derivative is preferably 0.01 parts by mass or more and 10 parts by mass or less, per 100 parts by mass of the polymer. When the adhesive composition of the present embodiment contains the alkyl phosphate salt as the adsorption inhibitor, the content of the alkyl phosphate salt is preferably 0.01 parts by mass or more and 10 parts by mass or less, per 100 parts by mass of the polymer.

As the chelate-forming metal inactivating agent, for example, a triazole group-containing compound or a benzotriazole group-containing compound may be used. These components are preferred as they have a high effect of inactivating the surface of a metal such as aluminum, and hardly influence the adhesiveness even if they are contained in the adhesive component. The chelate-forming metal inactivating agent may be used alone or in combination of two or more kinds thereof. When the adhesive composition of the present embodiment contains the chelate-forming metal inactivating agent, the content of the chelate-forming metal inactivating agent is preferably 0.01 parts by mass or more and 20 parts by mass or less, per 100 parts by mass of the polymer.

The total content (blending amount) of the corrosion inhibitor is preferably 0.01 parts by mass or more and 30 parts by mass or less, per 100 parts by mass of the polymer.

The adhesive composition of the present embodiment may further contain various additives such as a filler, a plasticizer, an age resister, an antioxidant, a pigment (dye), a flame retardant, a solvent, a surfactant (leveling agent), a rust inhibitor, an tackifying resin, and an antistatic agent. The total content of these components is not limited as long as the effects of the present invention are exhibited, but the total content is preferably 0.01 parts by mass or more and 20 parts by mass or less, more preferably 10 parts by mass or less, and still more preferably 5 parts by mass or less, per 100 parts by mass of the polymer.

Examples of the filler include silica, iron oxide, zinc oxide, aluminum oxide, titanium oxide, barium oxide, magnesium oxide, calcium carbonate, magnesium carbonate, zinc carbonate, agalmatolite clay, kaolin clay, and calcined clay.

As the plasticizer, the known or common plasticizers that are used for the general resin compositions may be used. Examples thereof include: oils such as paraffin oil and process oil; liquid rubber such as liquid polyisoprene, liquid polybutadiene, and liquid ethylenepropylene rubber; tetrahydrophthalic acid, azelaic acid, benzoic acid, phthalic acid, trimellitic acid, pyromellitic acid, adipic acid, sebacic acid, fumaric acid, maleic acid, itaconic acid, citric acid, and derivatives thereof; dioctyl phthalate (DOP), dibutyl phthalate (DBP), dioctyl adipate, diisononyl adipate (DINA), and isodecyl succinate.

Examples of the age resister include hindered phenol-based compounds or aliphatic and aromatic hindered amine-based compounds.

Examples of the antioxidant include butylated hydroxytoluene (BHT) and butylated hydroxyanisole (BHA).

Examples of the pigment include an inorganic pigment such as titanium dioxide, zinc oxide, ultramarine, red iron oxide, lithopone, lead, cadmium, iron, cobalt, aluminum, hydrochlorides or sulfates, and an organic pigment such as an azo pigment or a copper phthalocyanine pigment.

Examples of the rust inhibitor include zinc phosphate, tannic acid derivatives, phosphate, basic sulfonate, and various rust preventive pigments.

Examples of the adhesion-imparting agent include a titanium coupling agent and a zirconium coupling agent.

Examples of the antistatic agent generally include a quaternary ammonium salt or a hydrophilic compound such as polyglycolic acid or ethylene oxide derivative.

Examples of the tackifying resin include a polyamide-based tackifying resin, an epoxy-based tackifying resin and an elastomer-based tackifying resin, in addition to a rosin-based tackifying resin, a terpene-based tackifying resin, a phenol-based tackifying resin, a hydrocarbon-based tackifying resin, and a ketone-based tackifying resin. The tackifying resin may be used alone or in combination of two or more kinds thereof.

### Method For Producing Adhesive Composition

The adhesive composition of the present invention is not limited, and can be produced by appropriately stirring and mixing a polymer, an ionic liquid, an orientation material, and a crosslinking agent, polyethylene glycol, a conductive filler, and the like to be blended as necessary.

### Adhesive Sheet

### Configuration of Adhesive Sheet

The adhesive sheet of the present embodiment is not limited as long as it has at least one adhesive layer (hereinafter, also referred to as “electrically debondable adhesive layer”) formed from the adhesive composition of the present embodiment described above. The adhesive sheet of the present embodiment may have an adhesive layer (hereinafter, may be referred to as “another adhesive layer”) free of an ionic liquid, in addition to the electrically debondable adhesive layer. In addition to the above, the adhesive sheet of the present embodiment may include a substrate, a conductive layer, a conduction substrate, an intermediate layer, an undercoat layer, and the like. The adhesive sheet of the present embodiment may be, for example, rolled in a roll shape or in a sheet shape. The “adhesive sheet” shall also include the meaning of “adhesive tape”. That is, the adhesive sheet of the present embodiment may be an adhesive tape having a tape shape.

The adhesive sheet of the present embodiment may be a (substrateless) double-sided adhesive sheet including only the electrically debondable adhesive layer without a substrate, that is, a double-sided adhesive sheet including no substrate layer. The adhesive sheet of the present embodiment may be a double-sided adhesive sheet including a substrate, both surfaces of which are the adhesive layer (electrically debondable adhesive layer or another adhesive layer). The adhesive sheet of the present embodiment may be a single-sided adhesive sheet including a substrate, only one surface of which is an adhesive layer (electrically debondable adhesive layer or another adhesive layer). The adhesive sheet of the present embodiment may include a separator (release liner) for protecting the surface of the adhesive layer. Alternatively, the separator is not included in the adhesive sheet of the present embodiment.

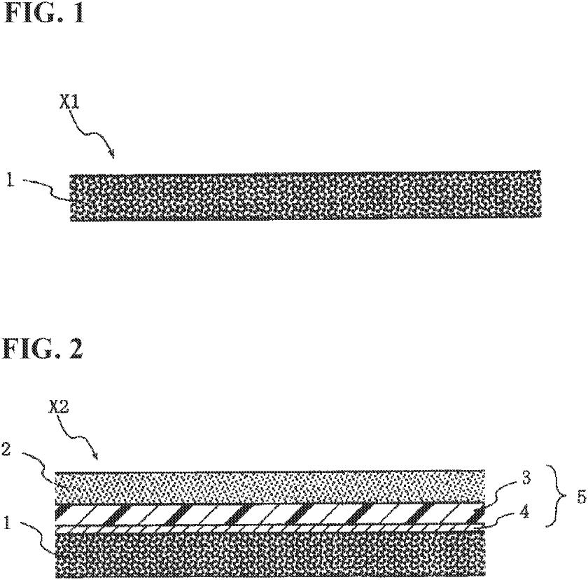

The structure of the adhesive sheet of the present embodiment is not limited, but the adhesive sheet preferably includes an adhesive sheet X1 shown in FIG. 1, an adhesive sheet X2 showing a laminated structure in FIG. 2, and an adhesive sheet X3 showing a laminated structure in FIG. 3. The adhesive sheet X1 is a substrateless double-sided adhesive sheet including an electrically debondable adhesive layer 1 only. The adhesive sheet X2 is a substrate-attached double-sided adhesive sheet having a layer configuration including an adhesive layer 2, a conduction substrate 5 (substrate 3 and conductive layer 4), and the electrically debondable adhesive layer 1. The adhesive sheet X3 is a substrate-attached double-sided adhesive sheet having a layer configuration including the adhesive layer 2, the conduction substrate 5 (substrate 3 and conductive layer 4), the electrically debondable adhesive layer 1, another conduction substrate 5 (substrate 3 and conductive layer 4), and another adhesive layer 2. In the conduction substrate 5 of the adhesive sheets X2 and X3 shown in FIGS. 2 and 3, the substrate 3 is not essential and only the conductive layer 4 may be present. The adhesive sheet X2 in FIG. 2 may be a single-sided adhesive sheet free of the adhesive layer 2.

The substrate 3 is not limited, but examples thereof include a paper-based substrate such as paper, a fiber-based substrate such as cloth and nonwoven fabric, a plastic substrate such as a film or sheet made of various plastics (a polyolefin-based resin such as polyethylene and polypropylene, a polyester-based resin such as polyethylene terephthalate, an acrylic resin such as polymethyl methacrylate, and the like), and a laminate thereof. The substrate may have a form of a single layer and may have a form of multi-layers. If necessary, the substrate may be subjected to various treatments such as a back-face treatment, an antistatic treatment, and an undercoating treatment.

The conductive layer 4 is not limited as long as it is a layer having conductivity, but may be a metal-based substrate such as a metal foil (for example, aluminum, magnesium, copper, iron, tin, and gold) and a metal plate (for example, aluminum, magnesium, copper, iron, tin, and silver), a conductive polymer, and the like. The conductive layer 4 may be a metal-deposited film provided on the substrate 3.

The conduction substrate 5 is not limited as long as it is a substrate having a conductive layer (carrying a current), but includes a substrate having a metal layer formed on a surface thereof. Examples of the substrate include a substrate having a metal layer formed on a surface of the substrate exemplified above by a method such as a plating method, a chemical vapor deposition, or sputtering. Examples of the metal layer include the metal, metal plate and conductive polymer exemplified above.

It is preferable that the adherend on both sides of the adhesive sheet X1 is an adherend having a metal adherend surface. It is preferable that an adherend at the side of the electrically debondable adhesive layer 1 of the adhesive sheet X2 is an adherend having a metal adherend surface.

Examples of the metal adherend surface include a surface made of a metal having conductivity and containing, for example, aluminum, copper, iron, magnesium, tin, gold, silver, or lead as a main component, and among these, a surface made of a metal containing aluminum is preferred. Examples of the adherend having a metal adherend surface include a sheet, a component, or a plate that is made of a metal containing, for example, aluminum, copper, iron, magnesium, tin, gold, silver or lead as a main component. An adherend other than the adherend having a metal adherend surface is not limited, but examples thereof include a fiber sheet such as paper, cloth, or nonwoven fabric, and a film or a sheet made of various plastics.

The thickness of the electrically debondable adhesive layer 1 is preferably 1 µm or more and 1,000 µm or less from the viewpoint of the initial adhesive force. The upper limit of the thickness of the electrically debondable adhesive layer 1 is more preferably 500 µm, still more preferably 100 µm, and particularly preferably 30 µm, and the lower limit thereof is more preferably 3 µm, still more preferably 5 µm, and particularly preferably 8 µm. When the adhesive sheet is a substrateless double-sided adhesive sheet including only the electrically debondable adhesive layer (adhesive sheet X1 shown in FIG. 1), the thickness of the electrically debondable adhesive layer is a thickness of the adhesive sheet.

The thickness of the adhesive layer 2 is preferably 1 µm or more and 2,000 µm or less from the viewpoint of adhesive force. The upper limit of the thickness of the adhesive layer 2 is more preferably 1,000 µm, still more preferably 500 µm, and particularly preferably 100 µm, and the lower limit thereof is more preferably 3 µm, still more preferably 5 µm, and particularly preferably 8 µm.

The thickness of the substrate 3 is preferably 10 µm or more and 1,000 µm or less. The upper limit of the thickness is more preferably 500 µm, still more preferably 300 µm, and particularly preferably 100 µm, and the lower limit thereof is more preferably 12 µm, and still more preferably 25 µm.

The thickness of the conductive layer 4 is preferably 0.001 µm or more and 1,000 µm or less. The upper limit of the thickness is more preferably 500 µm, still more preferably 300 µm, even more preferably 50 µm, and yet still more preferably 10 µm, and the lower limit thereof is more preferably 0.01 µm, still more preferably 0.03 µm, and even more preferably 0.05 µm.

The thickness of the conductive substrate 5 is preferably 10 µm or more and 1,000 µm or less. The upper limit of the thickness is more preferably 500 µm, still more preferably 300 µm, and particularly preferably 100 µm, and the lower limit thereof is more preferably 12 µm, and still more preferably 25 µm.

The surfaces of the electrically debondable adhesive layer and another adhesive layer of the adhesive sheet of the present embodiment may be protected by a separator (release liner). The separator is not limited, but examples thereof include a release liner in which a surface of a substrate (liner substrate) such as paper or plastic film has been silicone-treated, and a release liner in which a surface of a substrate (liner substrate) such as paper or plastic film has been laminated with a polyolefin-based resin. The thickness of the separator is not limited, but is preferably 10 µm or more and 100 µm or less.

The thickness of the adhesive sheet of the present embodiment is preferably 20 µm or more and 3,000 µm or less. The upper limit of the thickness is more preferably 1,000 µm, still more preferably 300 µm, and particularly preferably 200 µm, and the lower limit thereof is more preferably 30 µm, and still more preferably 50 µm.

In particular, in the case of the adhesive sheet X2 shown in FIG. 2, the thickness of the adhesive sheet is preferably 50 µm or more and 2,000 µm or less. The upper limit of the thickness is more preferably 1,000 µm, and still more preferably 200 µm, and the lower limit thereof is more preferably 80 µm, and still more preferably 100 µm.

In particular, in the case of the adhesive sheet X3 shown in FIG. 3, the thickness of the adhesive sheet is preferably 100 µm or more and 3,000 µm or less. The upper limit of the thickness is more preferably 1,000 µm, and still more preferably 300 µm, and the lower limit thereof is more preferably 150 µm, and still more preferably 200 µm.

### Method for Producing Adhesive Sheet

As the method for producing the adhesive sheet of the present embodiment, a known or common production method can be used. For example, for the electrically debondable adhesive layer in the adhesive sheet of the present embodiment, a method in which a solution of the adhesive composition of the present embodiment which is dissolved in a solvent as needed is applied onto a separator and dried and/or cured may be used. In addition, for another adhesive layer, a method in which a solution of the adhesive composition free of the ionic liquid, the orientation material, and the additive that is dissolved in a solvent as needed is applied onto a separator and dried and/or cured may be used. As the solvent and the separator, those described above may be used.

In the applying, a commonly used coater (for example, a gravure roll coater, a reverse roll coater, a kiss roll coater, a dip roll coater, a bar coater, a knife coater, and a spray roll coater) can be used.

The electrically debondable adhesive layer and another adhesive layer can be produced by the method described above, and the adhesive sheet of the present embodiment can be produced by appropriately laminating the electrically debondable adhesive layer and another adhesive layer on the substrate, the conductive layer and the conduction substrate. The adhesive sheet may be produced by using the substrate, the conductive layer, and the conduction substrate, instead of the separator, and applying the adhesive composition.

### Electrical Debonding Method of Adhesive Sheet

Debonding of the adhesive sheet of the present embodiment from an adherend can be performed by generating a potential difference in a thickness direction of the electrically debondable adhesive layer by applying a voltage to the electrically debondable adhesive layer. For example, when an adherend having a metal adherend surface is located on both sides of the adhesive sheet X1, debonding can be performed by carrying a current to metal adherend surfaces on both sides and applying a voltage to the electrically debondable adhesive layer. When an adherend having a metal adherend surface is located at the electrically debondable adhesive layer side of the adhesive sheet X2, debonding can be performed by carrying a current to the conductive adherend and the conductive layer 4 and applying a voltage to the electrically debondable adhesive layer. In the case of the adhesive sheet X3, debonding can be performed by carrying a current to the conductive layers 4 on both sides and applying a voltage to the electrically debondable adhesive layer. The current-carrying is preferably performed by connecting terminals to one end and the other end of the adhesive sheet such that a voltage is applied to the entire electrically debondable adhesive layer. The one end and the other end may be a part of the adherend having a metal adherend surface when the adherend has a metal adherend surface. During the debonding, a voltage may be applied after adding water to the interface between the metal adherend surface and the electrically debondable adhesive layer.

The applied voltage and the voltage application time during electric debonding are not limited as long as the adhesive layer or the adhesive sheet can be debonded from the adherend. Preferred ranges of those are described below.

The applied voltage is preferably 1 V or more, more preferably 3 V or more, and still more preferably 6 V or more. In addition, the applied voltage is preferably 100 V or less, more preferably 50 V or less, still more preferably 30 V or less, and particularly preferably 15 V or less.

The voltage application time is preferably 60 seconds or shorter, more preferably 40 seconds or shorter, still more preferably 20 seconds or shorter, and particularly preferably 10 seconds or shorter. In such a case, the workability is excellent. Shorter application time is preferred, and the voltage application time is generally 1 second or longer.

### Uses of Adhesive Sheet

An adhesive layer that is cured by ultraviolet (UV) radiation and debonded, or an adhesive layer that is debonded by heat are one of the common re-debonding technology. An adhesive sheet using such an adhesive layer cannot be used when ultraviolet (UV) radiation is difficult or heat causes damages in a member, which is an adherend. Ultraviolet rays and heat are not used for the adhesive sheet of the present embodiment including the electrically debondable adhesive layer, and thus cleavage-debonding can be easily performed by applying a voltage without damaging a member, which is an adherend. Therefore, the adhesive sheet of the present embodiment is suitable for use in fixation of a secondary battery (for example, lithium ion battery pack) used in a mobile terminal such as a smart phone, mobile phone, a notebook computer, a video camera, or a digital camera to a case.

Examples of a rigid member to which the adhesive sheet of the present embodiment bonds include a silicon substrate for use in a semiconductor wafer, a sapphire substrate for LED, a SiC substrate and a metal base substrate, a TFT substrate and a color substrate for a display, and a base substrate for an organic EL panel. Examples of a brittle member to which a double-sided adhesive sheet bonds include a semiconductor substrate such as a compound semiconductor substrate, a silicon substrate for use in MEMS device, a passive matrix substrate, a surface cover glass for a smart phone, OGS (One Glass Solution) substrate including the cover glass and a touch panel sensor, which is provided on the cover glass, an organic substrate and an organic/inorganic hybrid substrate including silsesquioxane as a main component, a flexible glass substrate for a flexible display, and a graphene sheet.

### Joined Body

A joined body of the present embodiment has a portion of a laminated structure including an adherend having a metal adherend surface, and an adhesive sheet having an electrically debondable adhesive layer bonding to the metal adherend surface. Examples of the adherend having a metal adherend surface include those made of metals including, for example, aluminum, copper, iron, magnesium, tin, silver, and lead as a main component. Among these, a metal including aluminum is preferred.

Examples of the joined body of the present embodiment include: a joined body including the adhesive sheet X1 and adherends having a metal adherend surface provided on both sides of the electrically debondable adhesive layer 1; a joined body including the adhesive sheet X2, an adherend having a metal adherend surface provided on the electrically debondable adhesive layer 1 side, and an adherend provided on the adhesive layer 2 side; and a material including the adhesive sheet X3 and adherends provided on both sides of the adhesive layer 2.

### EXAMPLES

Hereinafter, the present invention will be specifically described with reference to Examples, but the present invention is not limited to these Examples. The weight average molecular weight described below is measured using a gel permeation chromatography (GPC) method by the above-described method.

### Examples 1 to 4 and Comparative Examples 1 to 3

### Preparation of Polymer Solution

### Preparation of Acrylic Polymer 1 Solution

Into a separable flask, 95 parts by mass of n-butyl acrylate (BA) and 5 parts by mass of acrylic acid (AA) as monomer components and 250 parts by mass of ethyl acetate as a polymerization solvent were charged and stirred for 1 hour while introducing nitrogen gas. In this manner, oxygen in the polymerization system was removed, and then 0.2 parts by mass of 2,2′-azobisisobutyronitrile (AIBN) as a polymerization initiator was added. The temperature was raised to 63° C. and a reaction was performed for 6 hours. Thereafter, ethyl acetate was added to obtain an acrylic polymer 1 solution (BA/AA (95/5)) having a solid content concentration of 28.6 mass%.

### Preparation of Adhesive Composition

The acrylic polymer 1 solution obtained above, the ionic liquid, the orientation material, and the crosslinking agent shown below were added, stirred, and mixed to obtain adhesive compositions of Examples 1 to 4 and Comparative Examples 1 to 3. Table 1 shows the blending amount (parts by mass) of each component.

The values of each component in Table 1 mean parts by mass.

The abbreviations of the polymer, the ionic liquid, the orientation material, and the crosslinking agent in Table 1 are as follows.

### Ionic Liquid

AS110: cation: 1-ethyl-3-methylimidazolium cation, anion: bis(fluorosulfonyl)imide anion, trade name “ELEXCELAS-110”, manufactured by DKS Co. Ltd.

### Orientation Material

4-cyanophenyl-4-butylbenzoate: manufactured by Fujifilm Wako Pure Chemical Industries, Ltd.

Tarns, trans-4-butyl-4′-vinyl bicyclohexyl: manufactured by Tokyo Chemical Industry Co., Ltd.

4-cyano-4′-heptylbiphenyl: manufactured by Tokyo Chemical Industry Co., Ltd.

### Crosslinking Agent

V-05: polycarbodiimide resin, trade name “CARBODILITE V-05”, manufactured by Nisshinbo Chemical Inc.

### Evaluation

### Initial Adhesive Force

The adhesive composition of each example was applied, using an applicator, onto a release-treated surface of a polyethylene terephthalate separator (“MRF38” (trade name) manufactured by Mitsubishi Plastics, Inc.) whose surface was subjected to a release treatment, so as to have a uniform thickness of the adhesive composition. Next, the resulting coating film was dried by heating at 130° C. for 3 minutes to obtain an electrically debondable adhesive layer (adhesive sheet) having a thickness of 30 µm.

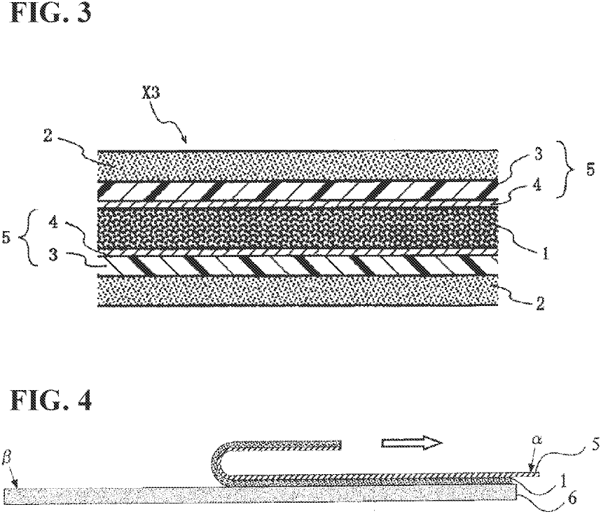

Next, the obtained electrically debondable adhesive layer (adhesive sheet) was made into a sheet having a size of 10 mm × 80 mm, and a metal layer surface of a metal layer-attached film (trade name “BR1075”, manufactured by Toray Film Co., Ltd., thickness: 25 µm, size: 10 mm × 100 mm) was allowed to bond to a separator-free surface of the adhesive sheet, to obtain a substrate-attached single-sided adhesive sheet. A separator of the substrate-attached single-sided adhesive sheet was peeled off, and a stainless steel plate (SUS304BA, φ 120 mm, thickness: 1.5 mm) as an adherend was allowed to bond to the peeled face such that one extremity of the adhesive sheet was protruded from the adherend by approximately 2 mm, and the resultant one was pressed by reciprocating a 2 kg roller one time. After allowing to stand in an environment of 23° C. for 30 minutes, a joined body including stainless steel plate 6/electrically debondable adhesive layer (adhesive sheet) ⅟metal layer-attached film (conduction substrate) 5 was obtained. The overview of the joined body is shown in FIG. 4. Thereafter, the adhesive sheet was peeled in an arrow method in FIG. 4 by a peeling tester (trade name “variation angle peeling tester YSP”, manufactured by Asahi Seiko Co., Ltd.), and the adhesive force in the 180° peeling test (tensile rate: 300 mm/min, peeling temperature: 23° C.) was measured. The measurement results are shown in Table 1.

### Adhesive Force After Voltage Application

The adhesive force during voltage application was measured in the same manner as the above initial adhesive force measurement, except that, after pressing by reciprocating a 2 kg roller one time, the obtained adhesive sheet was left to stand in an environment of 22° C. and 20% RH for 3 days and that, before the peeling, negative and positive electrodes of a DC current machine were attached to α and β points of the joined body in FIG. 4, a voltage of 10 V was applied for 10 seconds, and then the peeling was performed. The measurement results are shown in Table 1.

### Cleavage-Debonding Force

The adhesive composition of each example was applied, using an applicator, onto a release-treated surface of a polyethylene terephthalate separator (“MRF38” (trade name) manufactured by Mitsubishi Plastics, Inc.) whose surface was subjected to a release treatment, so as to have a uniform thickness of the adhesive composition. Next, the resulting coating film was dried by heating at 130° C. for 3 minutes to obtain an electrically debondable adhesive layer (adhesive sheet) having a thickness of 30 µm.

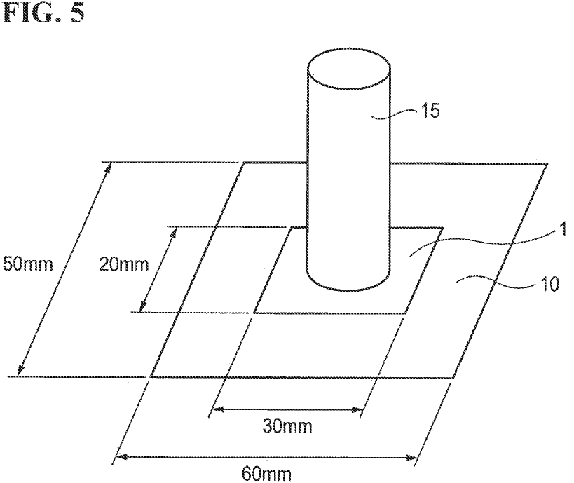

Next, the obtained electrically debondable adhesive layer (adhesive sheet) was formed into a sheet having a size of 25 mm × 30 mm, and a stainless steel plate (SUS304BA, 50 mm × 60 mm) was allowed to bond to a separator-free surface of the sheet. The separator of the adhesive sheet was peeled off, and a round bar (SUS304, φ 12.7 mm × 38 mm), which is used in a round-bar-type tensile peel strength test method described in JIS K6849 was attached to the peeled face, and the resultant one was press-bonded with a load of 5 kg for 10 seconds. After allowing to stand in an environment of 23° C. for 30 minutes, a joined body for a cleavage-debonding test, which includes SUS304BA plate 10/electrically debondable adhesive layer (adhesive sheet) ⅟round bar 15 as shown in FIG. 5, was obtained.

Thereafter, the round bar was pulled with a peeling tester (trade name: “Small desktop tester EZ-SX”, manufactured by Shimadzu Corporation) while holding down the SUS304BA plate, and an adhesive force at the cleavage-debonding test (tensile rate: 10 mm/min, peeling temperature: 23° C.) was measured as cleavage-debonding force. The measurement results are shown in Table 1.

### Electrical Cleavage-Debonding Force

An electrical cleavage-debonding force was measured in the same manner as in the measurement of cleavage-debonding force described above, except that, after the press-bonding with a load of 5 kg for 10 seconds, the obtained adhesive sheet was left in an environment of 23° C. and 50% RH for 48 hours, and that a positive electrode was attached to an SUS304BA plate of the joined body and a negative electrode was attached to a round bar, a voltage of 10 V was applied for 10 seconds before peeling, and then measurement was performed while applying a voltage. When the debonding can be performed at 25 N/12.7 mmφ or less, cleavage-debonding can be performed by applying a voltage. The measurement results are shown in Table 1. [Table 1]

TABLE 1

| Parts by mass | Comparative Example 1 | Comparative Example 2 | Comparative Example 3 | Example 1 | Example 2 | Example 3 | Example 4 |
|---|---|---|---|---|---|---|---|
| Acrylic polymer-1 | 100 | 100 | 100 | 100 | 100 | 100 | 100 |
| AS110 | 5 | 3 | 4 | 3 | 4 | 4 | 4 |
| 4-cyanophenyl-4-butylbenzoate | - | - | - | 2 | 2 | - | - |
| Tarns, trans-4-butyl-vinyl bicyclohexyl | - | - | - | - | - | 2 | - |
| 4-cyano -4′-heptylbiphenyl | - | - | - | - | - | - | 2 |
| V-05 | 0.5 | 0.5 | 0.5 | 0.5 | 0.5 | 0.5 | 0.5 |
| Initial adhesive force[N/cm] | 4.870 | 6.050 | 5.998 | 6.971 | 6.861 | 7.393 | 7.027 |
| Adhesive force after voltage application[N/cm] | 0.190 | 3.881 | 0.163 | 0.065 | 0.001 | 0.008 | 0.001 |
| Cleavage-debonding force[N/12.7 mmcp] | 100.9 | 102.8 | 100.4 | 114.7 | 102.7 | 103.4 | 106.4 |
| Electrical cleavage-debonding force[N/12.7 mmφ] | 32.8 | 103.1 | 31.9 | 22.9 | 12.8 | 12.9 | 15.2 |

As shown in Table 1, the adhesive layers formed of the adhesive compositions of Examples 1 to 4 had excellent adhesive force (initial adhesive force) before no voltage was applied, and the adhesive force was sufficiently decreased by applying a voltage. The adhesive force was sufficiently decreased by applying a voltage, and thus cleavage-debonding could be performed.

In contrast, in Comparative Examples 1 to 3 that contain no orientation material, initial adhesive force was lower than that in Examples, and the decrease in the adhesive force was insufficient even when a voltage was applied.

Although preferred embodiments of the present invention have been described above, the present invention is not limited to the above embodiments, and various modifications and substitutions can be added to the above embodiments without departing from the scope of the present invention.

The present application is based on a Japanese patent application (No. 2020-060439) filed on Mar. 30, 2020, contents of which are incorporated herein by reference.

REFERENCE SIGNS LIST

| X1, X2, X3 | | Adhesive sheet |
|---|---|---|
| 1 2 3 4 5 6 10 15 | Electrically debondable adhesive layer Adhesive layer Substrate Conductive layer Conduction substrate Stainless steel plate SUS304BA plate Round bar | |

1. An adhesive composition comprising:
a polymer;
an ionic liquid; and
an orientation material.

2. The adhesive composition according to claim 1,
wherein, after the adhesive layer is allowed to adhere to an adherend, an adhesive layer formed of the adhesive composition is cleavage-debonded from the adherend by applying a voltage of 10 V for 10 seconds.

3. The adhesive composition according to claim 2, wherein the cleavage-debonding is natural debonding.

4. The adhesive composition according to claim 1, wherein the adhesive composition comprises 4 parts by mass or more of the ionic liquid per 100 parts by mass of the polymer.

5. The adhesive composition according to claim 1, wherein the polymer comprises at least one selected from the group consisting of a polyester-based polymer, a urethane-based polymer, and an acrylic polymer.

6. The adhesive composition according to claim 5, wherein the acrylic polymer contains a unit derived from a polar group-containing monomer having a carboxyl group, an alkoxy group, a hydroxy group and/or an amide bond.

7. The adhesive composition according to claim 6, wherein a proportion of the polar group-containing monomer to total monomer components of the acrylic polymer is 0.1 to 35 mass%.

8. The adhesive composition according to claim 1, wherein the adhesive composition is for use in electrical debonding.

9. An adhesive sheet comprising an adhesive layer formed of the adhesive composition according to claim 1.

10. A joined body comprising:
an adherend having a metal adherend surface; and
the adhesive sheet according to claim 9,
wherein the adhesive layer of the adhesive sheet adheres to the metal adherend surface.

11. The adhesive composition according to claim 2, wherein the adhesive composition comprises 4 parts by mass or more of the ionic liquid per 100 parts by mass of the polymer.

12. The adhesive composition according to claim 3, wherein the adhesive composition comprises 4 parts by mass or more of the ionic liquid per 100 parts by mass of the polymer.

13. The adhesive composition according to claim 2, wherein the polymer comprises at least one selected from the group consisting of a polyester-based polymer, a urethane-based polymer, and an acrylic polymer.

14. The adhesive composition according to claim 3, wherein the polymer comprises at least one selected from the group consisting of a polyester-based polymer, a urethane-based polymer, and an acrylic polymer.

15. The adhesive composition according to claim 13, wherein the acrylic polymer contains a unit derived from a polar group-containing monomer having a carboxyl group, an alkoxy group, a hydroxy group and/or an amide bond.

16. The adhesive composition according to claim 15, wherein a proportion of the polar group-containing monomer to total monomer components of the acrylic polymer is 0.1 to 35 mass%.

17. The adhesive composition according to claim 14, wherein the acrylic polymer contains a unit derived from a polar group-containing monomer having a carboxyl group, an alkoxy group, a hydroxy group and/or an amide bond.

18. The adhesive composition according to claim 17, wherein a proportion of the polar group-containing monomer to total monomer components of the acrylic polymer is 0.1 to 35 mass%.
